(19) United States
(12) Patent Application Publication
(10) Pub. No.: US 2025/0094904 A1
(43) Pub. Date: Mar. 20, 2025

(54) SYSTEMS AND METHODS FOR RISK MANAGEMENT

(71) Applicant: Microsoft Technology Licensing, LLC, Redmond, WA (US)

(72) Inventor: Kirk Frank RUSSELL, Fort Collins, CO (US)

(73) Assignee: Microsoft Technology Licensing, LLC, Redmond, WA (US)

(21) Appl. No.: 18/470,638

(22) Filed: Sep. 20, 2023

(51) Int. Cl. G06Q 10/0635; G06Q 10/0637

(52) U.S. Cl. CPC G06Q 10/0635; G06Q 10/06375

(57) ABSTRACT

A computing system is provided for risk management. The computing system includes processing circuitry configured to receive input of a control opportunity score, a numerical status score, and one or a plurality of risk impact values for a respective plurality of target objectives for a given risk, calculate a residual risk value for the given risk based on the control opportunity score and an inherent risk value, calculate a relative risk value for the given risk based on the residual risk value, the numerical status score, and the one or the plurality of risk impact values, generate a prompt including the relative risk value and a description of the given risk, input the prompt into a generative model to generate a recommendation for mitigating the given risk, and output the recommendation generated by the generative model.

### BACKGROUND

Risk management includes the processes of identifying, assessing, and controlling threats, which could stem from a variety of sources, including financial uncertainty, legal liabilities, strategic management errors, accidents, and natural disasters, for example. One application of risk management techniques is in data center management. Data centers are collections of servers networked together and often used to provide cloud-based services to end users via the Internet. These systems are complex, and include many potential independent and interrelated causes of failure. A failure in a data center can lead to financial loss, loss of data, degraded user experience, and a drop in customer trust. A technical challenge exists to programmatically quantify risk and generate recommendations for managing the quantified risk in data centers, as well as other complex systems.

### SUMMARY

To address the above issues, a computing system is provided for risk management. The computing system includes processing circuitry, and memory storing instructions which are executed by the processing circuitry to receive input of a control opportunity score, a numerical status score, and one or a plurality of risk impact values for a respective plurality of target objectives for a given risk, calculate a residual risk value for the given risk based on the control opportunity score and an inherent risk value, calculate a relative risk value for the given risk based on the residual risk value, the numerical status score, and the one or the plurality of risk impact values, generate a prompt including the relative risk value and a description of the given risk, input the prompt into a generative model to generate a recommendation for mitigating the given risk, and output the recommendation generated by the generative model.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view showing a computing system according to a first example implementation.

FIG. 2 is a schematic view showing a computing system according to a second example implementation.

FIG. 3 is a schematic view showing inputs and outputs of the relative risk determination module and generative model of FIG. 1 or FIG. 2 according to an example implementation.

FIG. 4 is a schematic view showing an input and an output recommendation of the generative model of FIG. 1 or FIG. 2 according to an example implementation.

FIG. 5 is a table showing the calculations performed to calculate the relative risk value in the example of FIGS. 3 and 4.

FIG. 6 shows a flowchart for a first method for risk management according to one example implementation.

FIG. 7 shows a flowchart for a second method for risk management according to one example implementation.

FIG. 8 shows a schematic view of an example computing environment in which the computing system of FIG. 1 or FIG. 2 may be enacted.

### DETAILED DESCRIPTION

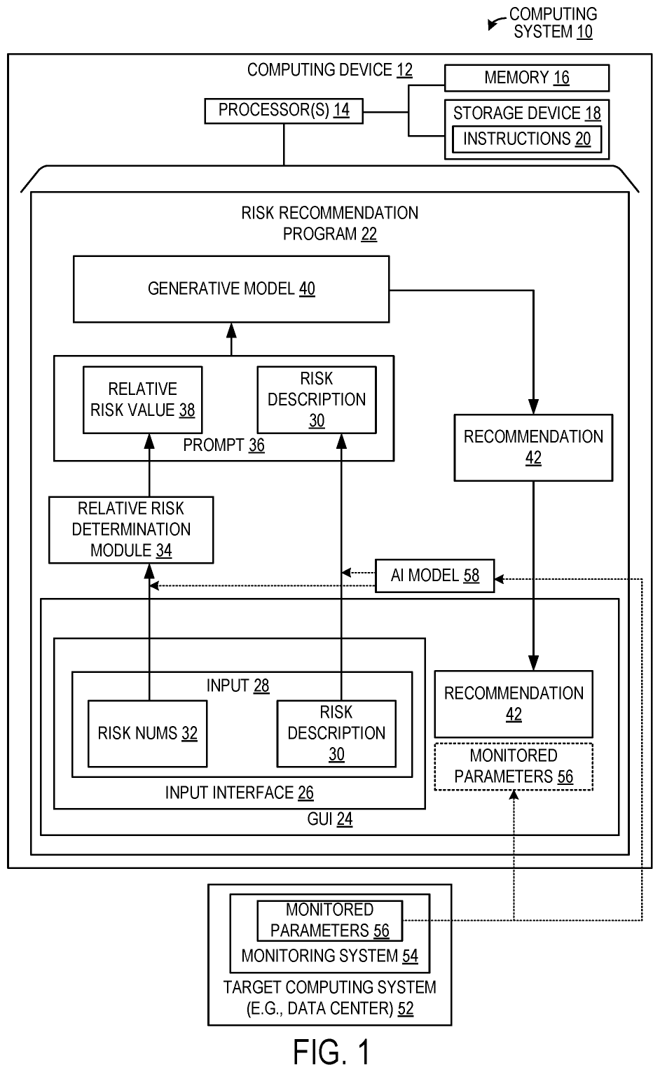

To address the issues described above, FIG. 1 illustrates a schematic view of a computing system 10 for use in risk management, according to a first example implementation. The computing system 10 includes a computing device 12 having processing circuitry 14, memory 16, and a storage device 18 storing instructions 20. In this first example implementation, the computing system 10 takes the form of a single computing device 12 storing instructions 20 in the storage device 18, including a risk recommendation program 22 that is executable by the processing circuitry 14 to perform various functions including the determination of a relative risk value by a relative risk determination module 34 and a trained generative model 40 configured to generate a recommendation for mitigating a given risk. The risk recommendation program 22 is executed by the processing circuitry 14 to receive an input 28 of a control opportunity score, a numerical status score, and one or a plurality of risk impact values for a respective plurality of target objectives for a given risk.

For simplicity, the trained generative model 40 will be henceforth referred to by way of example as a trained generative language model 40. However, it will be noted that a trained generative language model is merely one illustrative example of a trained generative model 40 that can be used in accordance with the described embodiments. A wide range of trained generative models 40 can be used, including multi-modal models, diffusion models, and generative adversarial networks, which may receive text, image, and/or audio inputs and generate text, image, and/or audio outputs, as discussed in further detail below.

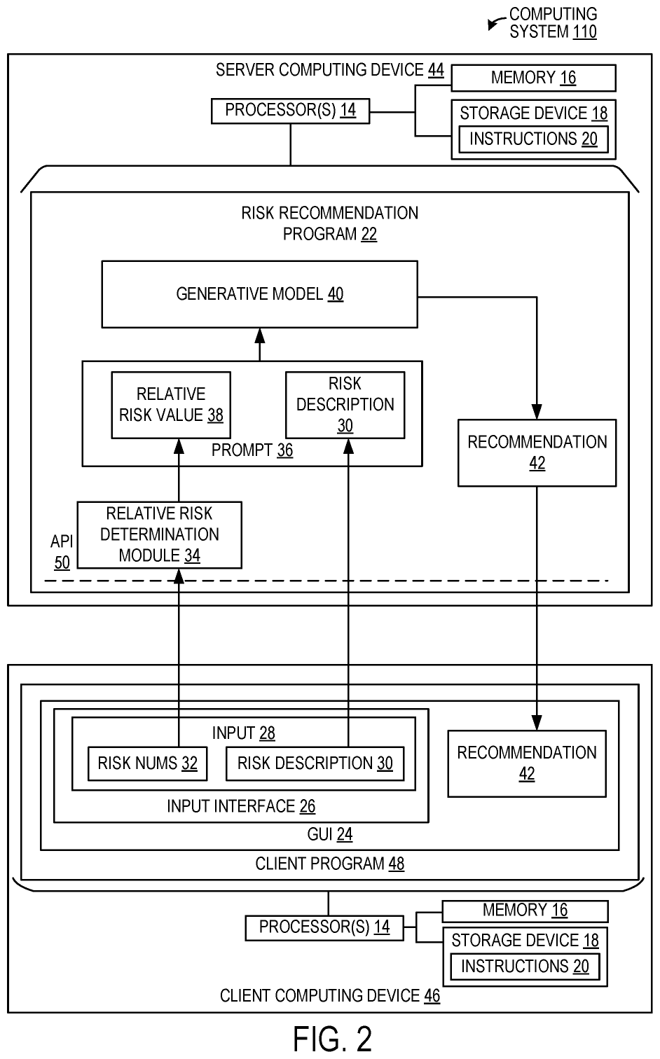

In the example of FIG. 1, the input 28 includes a set of risk numbers 32 and a risk description 30. The risk numbers 32 may include the control opportunity score, the numerical status score, and one or the plurality of risk impact values for the respective plurality of target objectives for the given risk. The relative risk determination module 34 receives the risk numbers 32 as input and calculates a residual risk for the given risk based on the control opportunity score and an inherent risk value, and also calculates a relative risk value 38 for the given risk based on the residual risk, the numerical status score, and the one or the plurality of risk impact values. The risk recommendation program 22 subsequently generates a prompt 36 including the relative risk value 38 and the description 30 of the given risk, and inputs the prompt 36 into the trained generative language model 40 to generate a recommendation 42 for mitigating the given risk. In this embodiment and the embodiment of FIG. 2 discussed below, risk numbers 32 alternatively may be replaced with another set of ranked values, such as A, B, C, and D, or High, Medium, and Low, which have corresponding numeric values associated with them.

In general, the processing circuitry 14 may be configured to receive, via an input interface 26 (in some implementations, the prompt interface API), natural language text input 28, which is incorporated into the prompt 36 and provided to the trained generative language model 40. The trained generative language model 40 receives the prompt 36, which includes the natural language text input 28 from the user for the trained generative language model 40 to generate a recommendation 42. The generative language model 40 generates, in response to the prompt 36, the recommendation 42. In turn, processing circuitry 14 is configured to output the recommendation 42 received from the generative model 40 to the user, for example via a display, file, electronic message, database entry, API message, etc. It will be understood that the natural language text input 28 may also be generated by and received from a software program, rather than directly from a human user.

The processing circuitry 14 is configured to cause the input interface 26 for the trained generative language model 40 to be presented. In some instances, the input interface 26 may be a portion of a graphical user interface (GUI) 24 for accepting user input and presenting information to a user. In other instances, the input interface 26 may be presented in non-visual formats such as an audio interface for receiving and/or outputting audio, such as may be used with a digital assistant. In yet another example the input interface 26 may be implemented as a prompt interface application programming interface (API). In such a configuration, the input to the input interface 26 may be made by an API call from a calling software program to the prompt interface API, and output may be returned in an API response from the prompt interface API to the calling software program. It will be understood that distributed processing strategies may be implemented to execute the software described herein, and the processing circuitry 14 therefore may include multiple processing devices, such as cores of a central processing unit, co-processors, graphics processing units, field programmable gate arrays (FPGA) accelerators, tensor processing units, etc., and these multiple processing devices may be positioned within one or more computing devices, and may be connected by an interconnect (when within the same device) or via a packet switched network links (when in multiple computing devices), for example. Thus, the processing circuitry 14 may be configured to execute the prompt interface API (e.g., input interface 26) for the trained generative language model 40.

The trained generative language model 40 is a generative model that has been configured through machine learning to receive input that includes natural language text and generate output that includes natural language text in response to the input. It will be appreciated that the trained generative language model 40 can be a large language model (LLM) having tens of millions to billions of parameters, non-limiting examples of which include GPT-3 and BLOOM. The trained generative language model 40 can be a multi-modal generative model configured to receive multi-modal input including natural language text input as a first mode of input and image, video, or audio as a second mode of input, and generate output including natural language text based on the multi-modal input. The output of the multi-modal model may additionally include a second mode of output such as image, video, or audio output. Non-limiting examples of multi-modal generative models include Kosmos-1, GPT-4 VISUAL (and LLaMA). Further, the trained generative language model 40 can be configured to have a generative pre-trained transformer architecture, examples of which are used in the GPT-3 and GPT-4 models.

Additionally or alternatively, the risk numbers 32 and risk description 30 may be automatically or algorithmically generated by an artificial intelligence (AI) model 58 instead of being inputted at the input interface 26 by a human operator. A target computing system 52 may be exemplified as a data center which is configured to manage vast amounts of data and ensure data availability. The target computing system 52 is populated with a multitude of systems, including but not limited to servers, switches, routers, and storage devices.

To maintain an optimal operating environment for these systems, not only to ensure their operational longevity but also to guarantee performance efficiency and prevent unscheduled downtimes, the target computing system 52 may be equipped with a comprehensive monitoring system 54. This monitoring system 54 may be configured to continuously oversee the myriad of operations and conditions within the data center, utilizing a diverse array of sensors strategically located throughout the infrastructure. These sensors may be calibrated to detect, measure, and record various monitored parameters 56, which may include but are not limited to ambient temperatures, humidity levels, power consumption rates, airflow rates, error rates in reading and writing from storage devices like hard drives and solid-state drives, and network latency, among others.

These monitored parameters 56 provide real-time insights into the operational state of the target computing system 52. For easy accessibility and user-friendly interpretation, these monitored parameters 56 may be displayed on the GUI 24, which may allow users to gain an immediate understanding of the current conditions within the target computing center 52, facilitating prompt action should anomalies arise.

The monitored parameters 56 may be received as input by the AI model 58, which may be configured to process and analyze the monitored parameters 56 to detect patterns, deviations, or anomalies that might signal potential risks or malfunctions. Through algorithmic processes, the AI model 58 may autonomously generate risk numbers 32 and accompanying risk descriptions 30 based on its analysis of the monitored parameters 56.

For example, when the monitoring system 54 detects an unexpected surge in temperature in a specific section of the data center, the AI model 58 may receive the monitored parameters 56 and generate corresponding risk numbers and a risk description 30, articulating the nature of the risk—in this case, “Server components overheating due to poor ventilation”.

Turning to FIG. 2, a computing system 110 according to a second example implementation is illustrated, in which the computing system 110 includes a server computing device 44 and a client computing device 46. Here, both the server computing device 44 and the client computing device may include respective processors 14, memory 16, and storage devices 18. Description of identical components to those in FIG. 1 will not be repeated. The client computing device 46 may be configured to present the input interface 26 as a result of executing a client program 48 by the processor 14 of the client computing device 46. However, as in the example of FIG. 1, the risk numbers 32 and risk description 30 may additionally or alternatively be generated by an AI model 58 instead of being inputted at the input interface 26 by a human operator. The client computing device 46 may be responsible for communicating between the user operating the client computing device 46 and the server computing device 44 which executes the risk recommendation program 22 and contains the relative risk determination module 34 and the generative language model 40, via an application programming interface (API) 50 of the risk recommendation program 22. The client computing device 46 may take the form of a personal computer, laptop, tablet, smartphone, smart speaker, etc. The same processes described above with reference to FIG. 1 may be performed, except in this case the natural language text input 28 and recommendation 42 may be communicated between the server computing device 44 and the client computing device via a network such as the Internet.

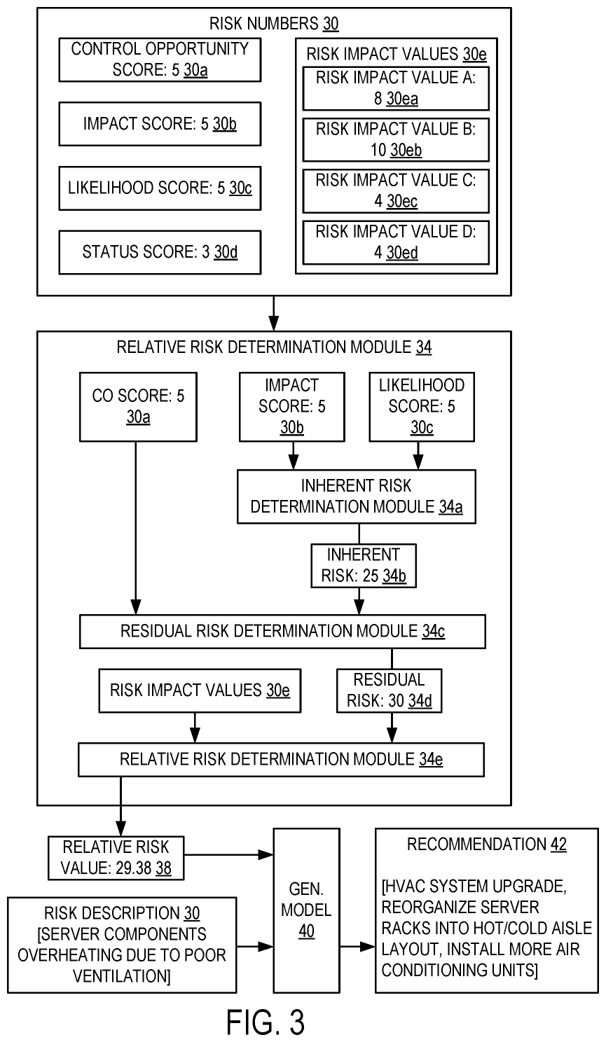

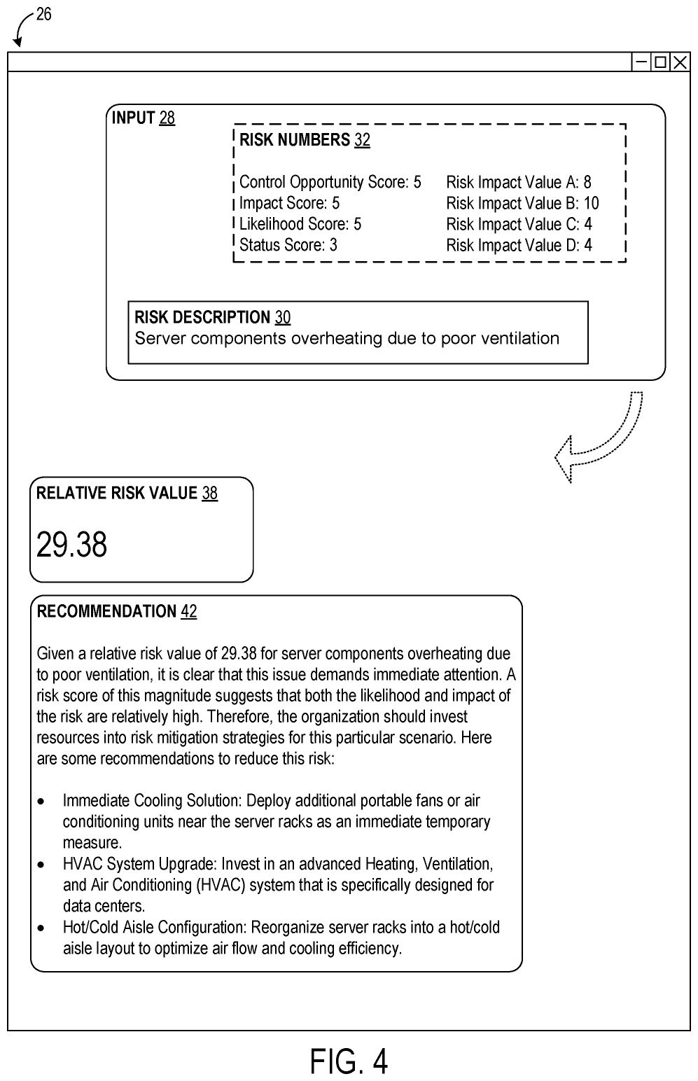

Turning to FIGS. 3 and 4, an example is described of risk numbers 32 which are inputted into the relative risk determination module 34 to generate a relative risk value 38, which is inputted into the generative language model 40 to generate a recommendation 42. In this example, the risk numbers 32 include a control opportunity score 30a (which is 5), an impact score 30b (which is 5), a likelihood score 30c (which is 5), and a numerical status score 30d (which is 3). The control opportunity score 30a evaluates the opportunity for implementing controls or safeguards to mitigate a given risk, and can be determined through feasibility studies and expert assessments. The impact score 30b quantifies the potential damage that could be caused if the given risk materializes, and may be obtained through expert assessments, historical data, or simulations. The likelihood score 30c quantifies the probability of the given risk occurring, which may be calculated from historical data or statistical modeling. The numerical status score 30d is one of a plurality of values on a scale from lowest risk to highest risk, providing a rough first-glance assessment of the severity of the given risk. For example, the lowest risk may be assigned a status score of one, a low risk may be assigned a status score of two, a high risk may be assigned a status score of 3, and the highest risk may be assigned a status score of 4.

The risk numbers 32 includes one or a plurality of risk impact values 30e for a respective plurality of target objectives for the given risk. In this example, there are four risk impact values 30e: risk impact value A 30ea, which is 8, risk impact value B 30eb, which is 10, risk impact value C 30ec, which is 4, and risk impact value D 30ed, which is 4. In the context of risk management for data centers, the risk impact values 30e may include target objectives such as reducing the number of hardware failures by 30% for servers, implementing a backup power supply system to reduce the risk of power outages by 20%, and conducting regular vulnerability assessments to identify and address potential security weaknesses to ensure 99% operational success.

The relative risk determination module 34 receives input of the risk numbers 32 to generate a relative risk value 38 for the given risk. The inherent risk determination module 34a of the relative risk determination module 34 receives input of the impact score 30b and the likelihood score 30c to generate an inherent risk value 34b, which is determined to be 25. The inherent risk value may be calculated as a product of the impact score 30b and the likelihood score 30c.

The residual risk determination module 34c of the relative risk determination module 34 receives the control opportunity score 30a and the inherent risk value 34b as input, and generates a residual risk value 34d, which is calculated to be 30. The residual risk value 34d may be calculated by calculating a quotient of the control opportunity score 30a divided by a first predetermined constant, multiplying the quotient by the inherent risk value 34b, then summing the resulting product with an additional quotient of the control opportunity score 30a divided by the first predetermined constant. Although the quotients of the control opportunity score 30a are divided by a first predetermined constant of 5 in this example, it will be appreciated that they may alternatively be divided by a different constant in other examples.

The relative risk determination module 34e receives the one or the plurality of risk impact values 30e and the residual risk value 34d as input, and generates a relative risk value 38, which is calculated to be 29.38. The relative risk determination module 34e may calculate a current averaged value weight for each of the one or a plurality of risk impact values 30e for the respective plurality of target objectives, and calculate a summed value weight by summing the calculated current averaged value weights for the one or the plurality of risk impact values 30e.

The relative risk value 38 may be calculated by multiplying the residual risk value 34d by the summed value weight, multiplying the resulting product by a quotient of a numerical status score divided by a second predetermined constant, and then summing the resulting product with an additional quotient of the numerical status score divided by the second predetermined constant. The second predetermined constant may be 2.5, for example.

The relative risk value 38 and the risk description 30 are inputted into the generative language model 40 to generate a recommendation 42. In this example, the description 30 of the given risk is “server components overheating due to poor ventilation”. The description 30 may also include a qualitative description of the one or the plurality of risk impact values 30e. The generative language model 40 may be trained using a database of risk descriptions, relative risk values, and recommendations. For example, personnel at a data center may maintain logs that chronicle daily operations, incidents, near misses, and observed risks. Risk analysts, quantifiers, and mitigation specialists may review the logs, describe and quantify the observed risks, and make recommendations accordingly. The logs including the risk descriptions, relative risk values, and recommendations may be used to train the generative language model 40 to associate the risk descriptions with their relative risk values and appropriate recommendations for risk mitigation.

The generated recommendation 42 notes that the relative risk value 38 of this magnitude suggests that both the likelihood and impact of the risk are relatively high. Accordingly, the recommendation 42 includes deploying additional portable fans or air conditioning units near servers, investing in a Heating, Ventilation, and Air Conditioning (HVAC) system, and reorganizing server racks into a hot/cold aisle layout to optimize air flow and cooling efficiency.

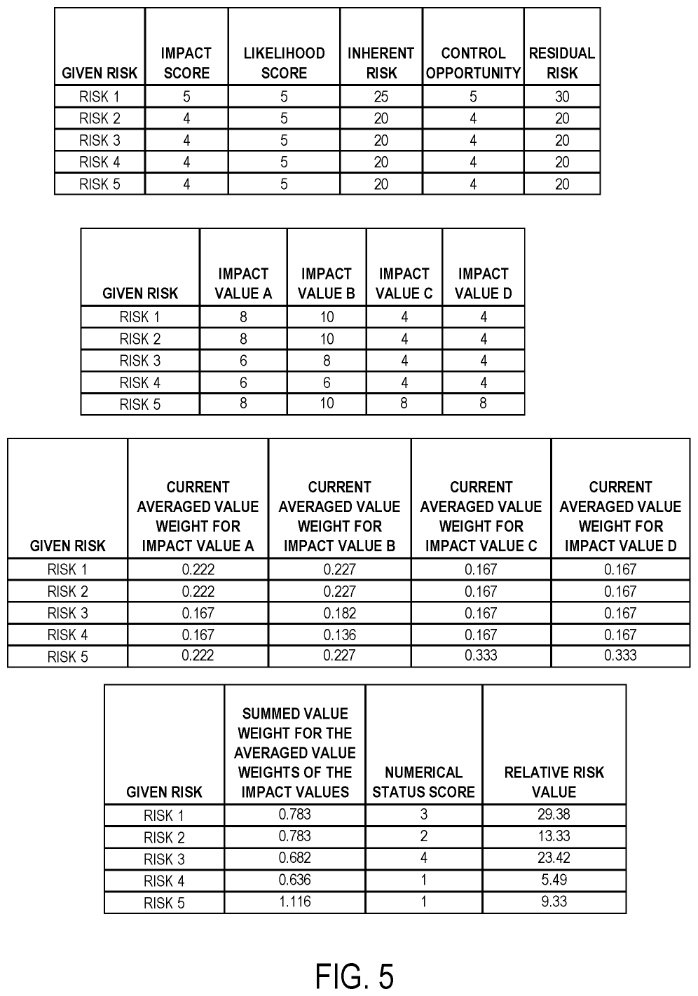

Turning to FIG. 5, a table is shown depicting the calculation of the current averaged value weight for each of the one or a plurality of risk impact values 30e for the respective plurality of target objectives, the calculation of the summed value weight which sums the calculated current averaged value weights for the one or the plurality of risk impact values, and the calculation of the relative risk value in the example of FIGS. 3 and 4. In FIG. 5, the relative risk value that is calculated in the example of FIGS. 3 and 4 is depicted as the relative risk value 29.38 of Risk 1 among the five Given Risks 1 through 5. The risks of Given Risks 1 through 5 are assessed relative to each other by determining relative risk values for each Given Risk. It will be noted that Risk 1 has the highest relative risk value at 29.38, followed by Risk 3 at 23.42, and Risk 2 at 13.33. Risk 4 has the lowest relative risk value at 5.49. Risk 5 has the second lowest relative risk value at 9.33.

For Risk 1, the current averaged value weight for impact value A is 0.222, which is calculated by dividing the impact value A 8 by the sum of the impact values A for all five Given Risks (8+8+6+6+8=36). Similarly, the current averaged value weight for impact value B is 0.227, which is calculated by dividing the impact value B 10 by the sum of the impact values B for all five Given Risks (10+10+8+6+10−44). The current averaged value weight for impact value C is 0.167, which is calculated by dividing the impact value C 4 by the sum of the impact values C for all five Given Risks (4+4+4+4+8−24). The current averaged value weight for impact value D is 0.167, which is calculated by dividing the impact value D 4 by the sum of the impact values D for all five Given Risks (4+4+4+4+8=24).

For Risk 1, the summed value weight 0.783 is calculated by summing the calculated averaged value weights for impact values A through D (0.222+0.227+0.167+0.167=0.783). The relative risk value 29.38 is calculated by multiplying the residual risk value 30 by the summed value weight 0.783, multiplying the resulting product by a quotient of the numerical status score 3 divided by a second predetermined constant (2.5 in this example), and then summing the resulting product with an additional quotient of the numerical status score divided by the predetermined constant.

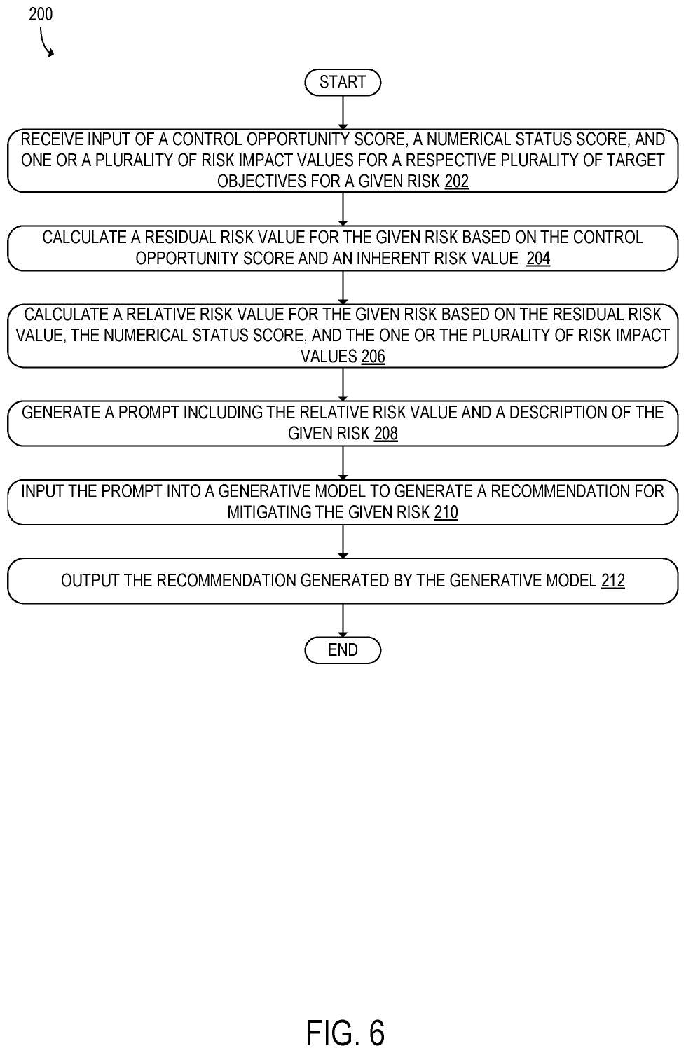

FIG. 6 shows a flowchart for a first method 200 for risk management according to one example implementation. The first method 200 may be implemented by the computing system 10 or 110 illustrated in FIGS. 1 and 2, respectively.

At step 202, the method 200 includes receiving input of a control opportunity score, a numerical status score, and one or a plurality of risk impact values for a respective plurality of target objectives for a given risk. At step 204, the method 200 includes calculating a residual risk value for the given risk based on the control opportunity score and an inherent risk value. The inherent risk value may be calculated as a product of the impact score and the likelihood score. The residual risk value may be calculated by calculating a quotient of the control opportunity score divided by a predetermined constant, multiplying the quotient by the inherent risk value, then summing the resulting product with an additional quotient of the control opportunity score divided by the predetermined constant.

At step 206, the method 200 includes calculating a relative risk value for the given risk based on the residual risk value, the numerical status score, and the one or the plurality of risk impact values. The relative risk value may be calculated by multiplying the residual risk by a summed value weight, multiplying the resulting product by a quotient of the numerical status score divided by a second predetermined constant, and then summing the resulting product with an additional quotient of the numerical status score divided by the second predetermined constant. The summed value weight may be calculated by summing current averaged value weights for each of the one or the plurality of risk impact values for the respective plurality of target objectives. The numerical status score may be one of a plurality of values on a scale from lowest risk to highest risk.

At step 208, the method 200 includes generating a prompt including the relative risk value and a description of the given risk, which may be a qualitative description of the one or the plurality of risk impact values. At step 210, the method 200 includes inputting the prompt into a generative model to generate a recommendation for mitigating the given risk. The generative model may be trained using a database or risk descriptions, relative risk values, and recommendations. At step 212, the method 200 includes outputting the recommendation generated by the generative model.

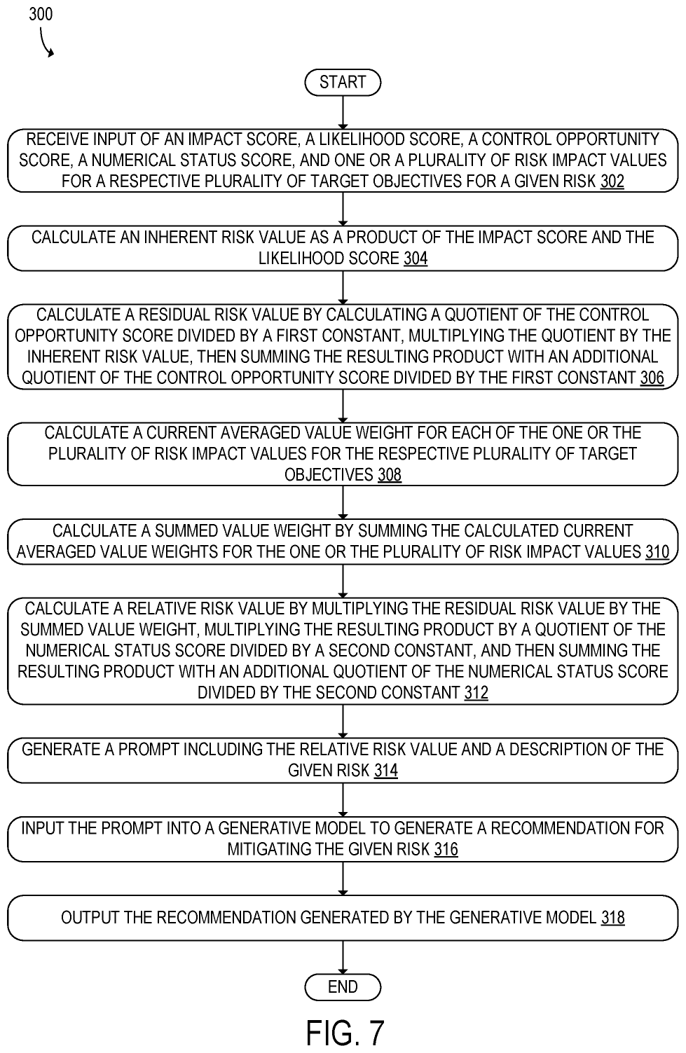

FIG. 7 shows a flowchart for a second method 300 for risk management according to one example implementation. The second method 300 may be implemented by the computing system 10 or 110 illustrated in FIGS. 1 and 2, respectively.

At step 302, the method 300 includes receiving input of an impact score, a likelihood score, a control opportunity score, a numerical status score, and one or a plurality of risk impact values for a respective plurality of target objectives for a given risk. At step 304, the method 300 includes calculating an inherent risk value as a product of the impact score and the likelihood score. At step 306, the method 300 includes calculating a residual risk value by calculating a quotient of the control opportunity score divided by a first predetermined constant, multiplying the quotient by the inherent risk value, then summing the resulting product with an additional quotient of the control opportunity score divided by the first predetermined constant. At step 308, the method 300 includes calculating a current averaged value weight for each of the one or the plurality of risk impact values for the respective plurality of target objectives.

At step 310, the method 300 includes calculating a summed value weight by summing the calculated current averaged value weights for the one or the plurality of risk impact values. At step 312, the method 300 includes calculating a relative risk value by multiplying the residual risk value by the summed value weight, multiplying the resulting product by a quotient of the numerical status score divided by a second predetermined constant, and then summing the resulting product with an additional quotient of the numerical status score divided by the second predetermined constant.

At step 314, the method 300 includes generating a prompt including the relative risk value and a description of the given risk. At step 316, the method 300 includes inputting the prompt into a generative model to generate a recommendation for mitigating the given risk. At step 318, the method 300 includes outputting the recommendation generated by the generative model.

The above-described systems and methods are capable of streamlining risk management practices in data-driven environments. By leveraging the power of generative models in empirical data, organizations can significantly enhance their ability to make informed decisions regarding various risk scenarios. This allows for real-time risk assessment and management, thereby ensuring that risks are not only identified but also quantified in terms of potential impact. This quantification facilitates prioritization, thereby ensuring that critical threats are addressed promptly, so that organizational assets are safeguarded more effectively.

While the above-described examples relate to risk management in data centers, the scope of the present disclosure is by no means limited to this particular use case. It will be appreciated that the underlying principles of evaluating and assessing the relative risks of different scenarios have wider applicability across various domains and sectors. For instance, in the field of IT security, the above-described systems and methods may be instrumental in evaluating the relative risks of potential cyber-attack scenarios, allowing IT professionals to proactively address vulnerabilities, patch, software, and fortify defense mechanisms. In the realm of disaster management systems, the above-described systems and methods may be instrumental in evaluating the relative risks of various potential natural or man-made disaster scenarios, so that emergency responders and planners can assess the potential outcomes of different mitigation strategies in the face of hurricanes, earthquakes, or even biohazards.

In some embodiments, the methods and processes described herein may be tied to a computing system of one or more computing devices. In particular, such methods and processes may be implemented as a computer-application program or service, an API, a library, and/or other computer-program product. In some embodiments, the methods and processes described herein may be tied to a computing system of one or more computing devices. In particular, such methods and processes may be implemented as a computer-application program or service, an API, a library, and/or other computer-program product.

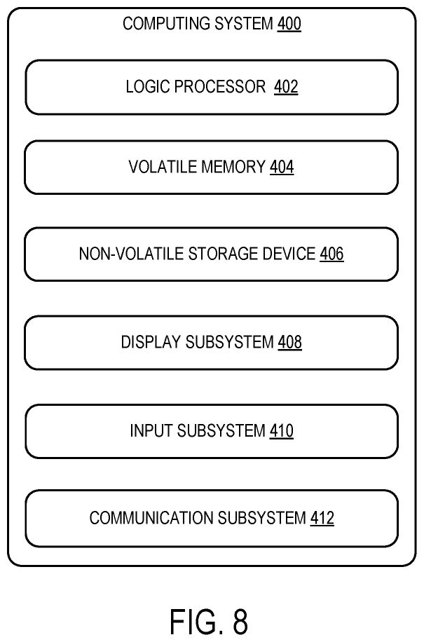

FIG. 8 schematically shows a non-limiting embodiment of a computing system 400 that can enact one or more of the methods and processes described above. Computing system 400 is shown in simplified form. Computing system 400 may embody the computing systems 10 and 110 described above and illustrated in FIGS. 1 and 2, respectively. Components of computing system 400 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 400 includes processing circuitry 402, volatile memory 404, and a non-volatile storage device 406. Computing system 400 may optionally include a display subsystem 408, input subsystem 410, communication subsystem 412, and/or other components not shown in FIG. 8.

Processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 402 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 402.

Non-volatile storage device 406 includes one or more physical devices configured to hold instructions executable by the processing circuitry to implement the methods and processes described herein. When such methods and processes are implemented, the state of non-volatile storage device 406 may be transformed—e.g., to hold different data.

Non-volatile storage device 406 may include physical devices that are removable and/or built in. Non-volatile storage device 406 may include optical memory, semiconductor memory, and/or magnetic memory, or other mass storage device technology. Non-volatile storage device 406 may include nonvolatile, dynamic, static, read/write, read-only, sequential-access, location-addressable, file-addressable, and/or content-addressable devices. It will be appreciated that non-volatile storage device 406 is configured to hold instructions even when power is cut to the non-volatile storage device 406.

Volatile memory 404 may include physical devices that include random access memory. Volatile memory 404 is typically utilized by processing circuitry 402 to temporarily store information during processing of software instructions. It will be appreciated that volatile memory 404 typically does not continue to store instructions when power is cut to the volatile memory 404.

Aspects of processing circuitry 402, volatile memory 404, and non-volatile storage device 406 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 400 typically implemented in software by a processor to perform a particular function using portions of volatile memory, which function involves transformative processing that specially configures the processor to perform the function. Thus, a module, program, or engine may be instantiated via processing circuitry 402 executing instructions held by non-volatile storage device 406, using portions of volatile memory 404. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 408 may be used to present a visual representation of data held by non-volatile storage device 406. The visual representation may take the form of a GUI. As the herein described methods and processes change the data held by the non-volatile storage device, and thus transform the state of the non-volatile storage device, the state of display subsystem 408 may likewise be transformed to visually represent changes in the underlying data. Display subsystem 408 may include one or more display devices utilizing virtually any type of technology. Such display devices may be combined with processing circuitry 402, volatile memory 404, and/or non-volatile storage device 406 in a shared enclosure, or such display devices may be peripheral display devices.

When included, input subsystem 410 may comprise or interface with one or more user-input devices such as a keyboard, mouse, touch screen, camera, or microphone.

When included, communication subsystem 412 may be configured to communicatively couple various computing devices described herein with each other, and with other devices. Communication subsystem 412 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 400 to send and/or receive messages to and/or from other devices via a network such as the Internet.

The following paragraphs further discuss several aspects of the present disclosure. One aspect provides a risk management system comprising processing circuitry, and a memory storing instructions which are executed by the processing circuitry to receive input of a control opportunity score, a numerical status score, and one or a plurality of risk impact values for a respective plurality of target objectives for a given risk, calculate a residual risk value for the given risk based on the control opportunity score and an inherent risk value, calculate a relative risk value for the given risk based on the residual risk value, the numerical status score, and the one or the plurality of risk impact values, generate a prompt including the relative risk value and a description of the given risk, input the prompt into a generative model to generate a recommendation for mitigating the given risk, and output the recommendation received from the generative model. In this aspect, additionally or alternatively, the residual risk value may be calculated by calculating a quotient of the control opportunity score divided by a first predetermined constant, multiplying the quotient by the inherent risk value, then summing the resulting product with an additional quotient of the control opportunity score divided by the first predetermined constant. In this aspect, additionally or alternatively, further input of an impact score and a likelihood score may be received. In this aspect, additionally or alternatively, the inherent risk value may be calculated as a product of the impact score and the likelihood score. In this aspect, additionally or alternatively, the relative risk value may be calculated by multiplying the residual risk value by a summed value weight, multiplying the resulting product by a quotient of the numerical status score divided by a second predetermined constant, and then summing the resulting product with an additional quotient of the numerical status score divided by the second predetermined constant. In this aspect, additionally or alternatively, the summed value weight may be calculated by summing current averaged value weights for each of the one or the plurality of risk impact values for the respective plurality of target objectives. In this aspect, additionally or alternatively, the numerical status score may be one of a plurality of values on a scale from lowest risk to highest risk. In this aspect, additionally or alternatively, the description may be a qualitative description of the one or the plurality of risk impact values. In this aspect, additionally or alternatively, the generative model may be trained using a database of risk descriptions, relative risk values, and recommendations. In this aspect, additionally or alternatively, the generative model may be a generative language model.

Another aspect provides a risk management method comprising receiving input of a control opportunity score, a numerical status score, and one or a plurality of risk impact values for a respective plurality of target objectives for a given risk, calculating a residual risk value for the given risk based on the control opportunity score and an inherent risk value, calculating a relative risk value for the given risk based on the residual risk value, the numerical status score, and the one or the plurality of risk impact values, generating a prompt including the relative risk value and a description of the given risk, inputting the prompt into a generative model to generate a recommendation for mitigating the given risk, and outputting the recommendation generated by the generative model. In this aspect, additionally or alternatively, the residual risk value may be calculated by calculating a quotient of the control opportunity score divided by a first predetermined constant, multiplying the quotient by the inherent risk value, then summing the resulting product with an additional quotient of the control opportunity score divided by the first predetermined constant. In this aspect, additionally or alternatively, further input of an impact score and a likelihood score may be received. In this aspect, additionally or alternatively, the inherent risk value may be calculated as a product of the impact score and the likelihood score. In this aspect, additionally or alternatively, the relative risk value may be calculated by multiplying the residual risk by a summed value weight, multiplying the resulting product by a quotient of the numerical status score divided by a second predetermined constant, and then summing the resulting product with an additional quotient of the numerical status score divided by the second predetermined constant. In this aspect, additionally or alternatively, the summed value weight may be calculated by summing current averaged value weights for each of the one or the plurality of risk impact values for the respective plurality of target objectives. In this aspect, additionally or alternatively, the numerical status score may be one of a plurality of values on a scale from lowest risk to highest risk. In this aspect, additionally or alternatively, the description may be a qualitative description of the one or the plurality of risk impact values. In this aspect, additionally or alternatively, the generative model may be trained using a database of risk descriptions, relative risk values, and recommendations.

Another aspect provides a risk management method comprising receiving input of an impact score, a likelihood score, a control opportunity score, a numerical status score, and one or a plurality of risk impact values for a respective plurality of target objectives for a given risk, calculating an inherent risk value as a product of the impact score and the likelihood score, calculating a residual risk value by calculating a quotient of the control opportunity score divided by a first predetermined constant, multiplying the quotient by the inherent risk value, then summing the resulting product with an additional quotient of the control opportunity score divided by the first predetermined constant, calculating a current averaged value weight for each of the one or the plurality of risk impact values for the respective plurality of target objectives, calculating a summed value weight by summing the calculated current averaged value weights for the one or the plurality of risk impact values, calculating a relative risk value by multiplying the residual risk value by the summed value weight, multiplying the resulting product by a quotient of the numerical status score divided by a second predetermined constant, and then summing the resulting product with an additional quotient of the numerical status score divided by the second predetermined constant, generating a prompt including the relative risk value and a description of the given risk, inputting the prompt into a generative model to generate a recommendation for mitigating the given risk, and outputting the recommendation generated by the generative model.

“And/or” as used herein is defined as the inclusive or V, as specified by the following truth table:

| A | B | A V B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A risk management system comprising:
processing circuitry; and
a memory storing instructions which are executed by the processing circuitry to:
receive input of a control opportunity score, a numerical status score, and one or a plurality of risk impact values for a respective plurality of target objectives for a given risk;
calculate a residual risk value for the given risk based on the control opportunity score and an inherent risk value;
calculate a relative risk value for the given risk based on the residual risk value, the numerical status score, and the one or the plurality of risk impact values;
generate a prompt including the relative risk value and a description of the given risk;
input the prompt into a generative model to generate a recommendation for mitigating the given risk; and
output the recommendation received from the generative model.

2. The risk management system of claim 1, wherein the residual risk value is calculated by calculating a quotient of the control opportunity score divided by a first predetermined constant, multiplying the quotient by the inherent risk value, then summing the resulting product with an additional quotient of the control opportunity score divided by the first predetermined constant.

3. The risk management system of claim 1, wherein further input of an impact score and a likelihood score are received.

4. The risk management system of claim 3, wherein the inherent risk value is calculated as a product of the impact score and the likelihood score.

5. The risk management system of claim 1, wherein the relative risk value is calculated by multiplying the residual risk value by a summed value weight, multiplying the resulting product by a quotient of the numerical status score divided by a second predetermined constant, and then summing the resulting product with an additional quotient of the numerical status score divided by the second predetermined constant.

6. The risk management system of claim 5, wherein the summed value weight is calculated by summing current averaged value weights for each of the one or the plurality of risk impact values for the respective plurality of target objectives.

7. The risk management system of claim 1, wherein the numerical status score is one of a plurality of values on a scale from lowest risk to highest risk.

8. The risk management system of claim 1, wherein the description is a qualitative description of the one or the plurality of risk impact values.

9. The risk management system of claim 1, wherein the generative model is trained using a database of risk descriptions, relative risk values, and recommendations.

10. The risk management system of claim 9, wherein the generative model is a generative language model.

11. A risk management method comprising:
receiving input of a control opportunity score, a numerical status score, and one or a plurality of risk impact values for a respective plurality of target objectives for a given risk;
calculating a residual risk value for the given risk based on the control opportunity score and an inherent risk value;
calculating a relative risk value for the given risk based on the residual risk value, the numerical status score, and the one or the plurality of risk impact values;
generating a prompt including the relative risk value and a description of the given risk;
inputting the prompt into a generative model to generate a recommendation for mitigating the given risk; and
outputting the recommendation generated by the generative model.

12. The risk management method of claim 11, wherein the residual risk value is calculated by calculating a quotient of the control opportunity score divided by a first predetermined constant, multiplying the quotient by the inherent risk value, then summing the resulting product with an additional quotient of the control opportunity score divided by the first predetermined constant.

13. The risk management method of claim 11, wherein further input of an impact score and a likelihood score are received.

14. The risk management method of claim 13, wherein the inherent risk value is calculated as a product of the impact score and the likelihood score.

15. The risk management method of claim 11, wherein the relative risk value is calculated by multiplying the residual risk by a summed value weight, multiplying the resulting product by a quotient of the numerical status score divided by a second predetermined constant, and then summing the resulting product with an additional quotient of the numerical status score divided by the second predetermined constant.

16. The risk management method of claim 15, wherein the summed value weight is calculated by summing current averaged value weights for each of the one or the plurality of risk impact values for the respective plurality of target objectives.

17. The risk management method of claim 11, wherein the numerical status score is one of a plurality of values on a scale from lowest risk to highest risk.

18. The risk management method of claim 11, wherein the description is a qualitative description of the one or the plurality of risk impact values.

19. The risk management method of claim 11, wherein the generative model is trained using a database of risk descriptions, relative risk values, and recommendations.

20. A risk management method comprising:
receiving input of an impact score, a likelihood score, a control opportunity score, a numerical status score, and one or a plurality of risk impact values for a respective plurality of target objectives for a given risk;
calculating an inherent risk value as a product of the impact score and the likelihood score;
calculating a residual risk value by calculating a quotient of the control opportunity score divided by a first predetermined constant, multiplying the quotient by the inherent risk value, then summing the resulting product with an additional quotient of the control opportunity score divided by the first predetermined constant;
calculating a current averaged value weight for each of the one or the plurality of risk impact values for the respective plurality of target objectives;
calculating a summed value weight by summing the calculated current averaged value weights for the one or the plurality of risk impact values;
calculating a relative risk value by multiplying the residual risk value by the summed value weight, multiplying the resulting product by a quotient of the numerical status score divided by a second predetermined constant, and then summing the resulting product with an additional quotient of the numerical status score divided by the second predetermined constant;
generating a prompt including the relative risk value and a description of the given risk;
inputting the prompt into a generative model to generate a recommendation for mitigating the given risk; and
outputting the recommendation generated by the generative model.
